(19) United States
(12) Patent Application Publication
(10) Pub. No.: US 2026/0311244 A1
(43) Pub. Date: Oct. 8, 2026

(54) Augmented Reality Nail Visualization System

(71) Applicant: Bobby Ta, Charlotte, NC (US)

(72) Inventor: Bobby Ta, Charlotte, NC (US)

(21) Appl. No.: 19/284,786

(22) Filed: Jul. 30, 2025

Related U.S. Application Data
(60) Provisional application No. 63/782,644, filed on Apr. 3, 2025.

(51) Int. Cl. G06Q 30/0601; G06F 3/0482; G06Q 10/087; G06T 19/00

(52) U.S. Cl. CPC G06Q 30/06434; G06F 3/0482; G06Q 10/0877; G06T 19/006

(57) ABSTRACT

A nail color visualization device is disclosed, which is a mobile/software application that provides a visual representation of potential nail colors, shapes, lengths, and designs on a user's hand. The mobile application interfaces with a user's phone camera. The mobile application will capture the user's hand and nail boundaries, providing a visual overlay of potential nail designs, shapes, lengths, and colors as selected by the user through options in the application.

### CROSS REFERENCE TO RELATED APPLICATION

The present application claims priority to, and the benefit of, U.S. Provisional Application No. 63/782,644, which was filed on Apr. 3, 2025, and is incorporated herein by reference in its entirety.

### FIELD OF THE INVENTION

The present invention relates generally to the field of nail color visualization devices. More specifically, the present invention relates to a mobile/software application and user interface that offers a visual representation of potential nail colors, shapes, lengths, and designs on the user's hand. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in nail color visualization devices. Generally, traditional nail color, shape, and length selection relies on physical swatches that are difficult to sanitize between uses and limited by physical inventory space. These swatches are also unable to show accurate representation on actual nails and are prone to fading, resulting in inaccurate representation. Further, maintaining optimal hygiene is important to prevent the spread of germs, bacteria, and viruses.

Additionally, it is also time-consuming for customers to test multiple colors which inevitably leads to customer frustration. Customers commonly experience ‘color, shape, and/or length regret’ after nail services are completed, requiring costly and time-consuming removals and reapplications when the chosen color does not meet expectations. Typically, salon inventory becomes overstocked with rarely used colors or frequently depleted of popular shades due to lack of data-driven inventory management, leading to increased cost and lost revenue opportunities.

Accordingly, there is a demand for an improved nail color visualization device that interfaces with the user's phone camera to create a visual overlay. More particularly, there is a demand for a nail color visualization device that ensures users can quickly visualize colors, shape, and length of nails.

Therefore, there exists a long-felt need in the art for a nail color visualization device the provides users with a mobile application and user interface that offers a visual representation of potential nail colors, shapes, lengths, and designs on the user's hand. There is also a long-felt need in the art for a nail color visualization device that interfaces with the user's phone camera, capturing their hand and nail boundaries to create a visual overlay of potential selected designs, colors, shapes, and lengths. Further, there is a long-felt need in the art for a nail color visualization device that removes accessibility barriers for mobility-challenged customers and prevents decision paralysis through rapid comparisons. Moreover, there is a long-felt need in the art for a device that ensures nail technicians can quickly visualize colors, shape, length, and designs for their clients, preventing customers from ordering incorrect or undesirable colors and being unhappy with their decision. Further, there is a long-felt need in the art for a nail color visualization device that solves inventory management with analytics that are calculated within the application via customer preference tracking, data analytics, and more. Finally, there is a long-felt need in the art for a nail color visualization device that has full inventory access to allow for more efficient management of supplies.

The subject matter disclosed and claimed herein, in one embodiment thereof, comprises a nail color visualization device. The device is a mobile/software application which provides a visual representation of potential nail colors, shapes, lengths, and designs on a user's hand. The mobile application interfaces with a user's phone camera. The mobile application will capture the user's hand and nail boundaries, providing a visual overlay of potential nail designs, shapes, lengths, and colors as selected by the user through options in the application.

The camera view screen will occupy the majority of the display and feature nail detection markers that identify and overlay color, shape and length onto fingernails. The color selection palette can be accessible via sideswipe or a bottom menu. There can be a salon branding area displaying a logo and business name. A quick-access history panel can also show recently viewed colors. A social sharing button would capture nail visualization, and a QR code scanner would be used for salon-specific color access. The software displays the ranking of the different colors or brands trending in the salon, city, and country. Toggle controls can be used for different nail finish types (i.e., glossy, matte, etc.). Other features can include color search and filter functionality, color information panels, salon inventory indicators, a virtual ‘try on’ button, settings menus, and a help-tutorial overlay for first-time users.

The mobile application will allow salon specific inventory entries to limit the options to only what is on site at the location being serviced. The mobile application allows users the benefit of approving a design or color on their nails before going through the process. The mobile application will have full inventory access to allow for more efficient management of supplies using advanced analytical review and allows social media integration for marketing and ordering.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a nail color visualization device. The device is a mobile/software application which provides a visual representation of potential nail colors, shapes, lengths, and designs on a user's hand. The mobile application interfaces with a user's phone camera. The mobile application will capture the user's hand and nail boundaries, providing a visual overlay of potential nail designs, shapes, lengths, and colors as selected by the user through options in the application.

In one embodiment, the nail color visualization device utilizes a smartphone, a tablet, a laptop or a desktop computer, etc., or any other suitable electronic device that has the required operating and memory parameters to support the mobile/software application of the present invention.

In one embodiment, the mobile application comprises an easy-to-use interface. A user would create an account and then log into the mobile application. The mobile application then interfaces with a user's phone camera. The mobile application will capture the user's hand and nail boundaries, providing a visual overlay of potential nail designs, shapes, lengths, and colors as selected by the user through options in the application. Specifically, the camera view screen will occupy the majority of the display and feature nail detection markers that identify and overlay color, shape and length onto fingernails.

In one embodiment, the color selection palette can be accessible via sideswipe or a bottom menu. There can be a salon branding area displaying a logo and business name. A quick-access history panel can also show recently viewed colors. A social sharing button would capture nail visualization, and a QR code scanner would be used for salon-specific color access.

In one embodiment, the software displays the ranking of the different colors or brands trending in the salon, city, and country. Toggle controls can be used for different nail finish types (i.e., glossy, matte, etc.). Other features can include color search and filter functionality, color information panels, salon inventory indicators, a virtual ‘try on’ button, settings menus, and a help-tutorial overlay for first-time users.

In one embodiment, the mobile application will allow salon specific inventory entries to limit the options to only what is on site at the location being serviced. The mobile application allows users the benefit of approving a design or color on their nails before going through the process. The mobile application will have full inventory access to allow for more efficient management of supplies using advanced analytical review and allows social media integration for marketing and ordering.

In one embodiment, the mobile application provides a secure website and/or smart phone app access by users. In addition, the device of the present invention may also include: a web server and Cloud database of nail salon identification and inventory data connectable to the mobile smartphone or portable tablet or computer device. Thus, the mobile application allows for providing salon specific inventory access via the web server and Cloud database.

In one embodiment of the invention, the nail salon identification and inventory data and data management software are maintained on a Microsoft Cloud server in a typical fashion, or other cloud server, such as the Adobe, Apple or Amazon cloud server, etc. A secure cloud server is used for the protection and security of nail salon identification and inventory data and user information data stored on the cloud server. Thus, nail salon identification and inventory data and user information data are sent to the cloud server and collected. Conveniently, the data is stored and managed with a data management software or program to manage the collected nail salon identification and inventory data, and user data. Accordingly, the data management software or program collects the information and links the information for use in the mobile application. Further, the linked information includes but is not limited to nail salon identification and inventory data, and user data, etc.

Typically, a cellular wireless data network embedded in the computer, tablet or smartphone, etc., transmits both nail salon identification and inventory data to a user. Such nail salon identification and inventory data can be processed by the user via a Cloud data management server.

In yet another embodiment, the nail color visualization device comprises a plurality of indicia.

In yet another embodiment, a method of displaying a visual representation of potential nail colors, shapes, lengths, and designs is disclosed. The method includes a mobile application to provide a visual representation of potential nail colors. The method also includes capturing the user's hand and nail boundaries. Further, the method comprises accessing the salon's inventory to determine the color selection palette available for a user. Finally, the method includes providing a visual overlay of potential nail designs and colors a user can swipe through to determine what nail design and color to choose.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the nail color visualization device of the present invention in accordance with the disclosed architecture;

FIG. 2 illustrates a perspective view of one embodiment of the nail color visualization device of the present invention showing the device in use in accordance with the disclosed architecture;

FIG. 3 illustrates a perspective view of one embodiment of the nail color visualization device of the present invention showing a user displaying different colors on their nails via the mobile application in accordance with the disclosed architecture;

FIG. 4 illustrates a perspective view of one embodiment of the nail color visualization device of the present invention showing the user displaying different colors on their nails via the mobile application in accordance with the disclosed architecture;

FIG. 5 illustrates a perspective view of one embodiment of the nail color visualization device of the present invention wherein the user is utilizing different nail options in accordance with the disclosed architecture;

FIG. 6 illustrates a flowchart showing the method of displaying a visual representation of potential nail colors, shapes, lengths, and designs in accordance with the disclosed architecture;

FIG. 7 is a schematic diagram illustrating one embodiment of the mobile application for providing visualization of nail colors and designs of the present invention in accordance with the disclosed architecture; and

FIG. 8 illustrates an exemplary user device that is used for installing the mobile application for providing visualization of nail colors and designs of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a nail color visualization device the provides users with a mobile application and user interface that offers a visual representation of potential nail colors, shapes, lengths, and designs on the user's hand. There is also a long-felt need in the art for a nail color visualization device that interfaces with the user's phone camera, capturing their hand and nail boundaries to create a visual overlay of potential selected designs, colors, shapes, and lengths. Further, there is a long-felt need in the art for a nail color visualization device that removes accessibility barriers for mobility-challenged customers and prevents decision paralysis through rapid comparisons. Moreover, there is a long-felt need in the art for a device that ensures nail technicians can quickly visualize colors, shape, length, and designs for their clients, preventing customers from ordering incorrect or undesirable colors and being unhappy with their decision. Further, there is a long-felt need in the art for a nail color visualization device that solves inventory management with analytics that are calculated within the application via customer preference tracking, data analytics, and more. Finally, there is a long-felt need in the art for a nail color visualization device that has full inventory access to allow for more efficient management of supplies.

The present invention, in one exemplary embodiment, is a novel nail color visualization device. The device is a mobile/software application which provides a visual representation of potential nail colors, shapes, lengths, and designs on a user's hand. The mobile application interfaces with a user's phone camera. The mobile application will capture the user's hand and nail boundaries, providing a visual overlay of potential nail designs, shapes, lengths, and colors as selected by the user through options in the application. In one embodiment, the device also includes a novel method of displaying a visual representation of potential nail colors, shapes, lengths, and designs. The method includes a mobile application to provide a visual representation of potential nail colors. The method also includes capturing the user's hand and nail boundaries. Further, the method comprises accessing the salon's inventory to determine the color selection palette available for a user. Finally, the method includes providing a visual overlay of potential nail designs and colors a user can swipe through to determine what nail design and color to choose.

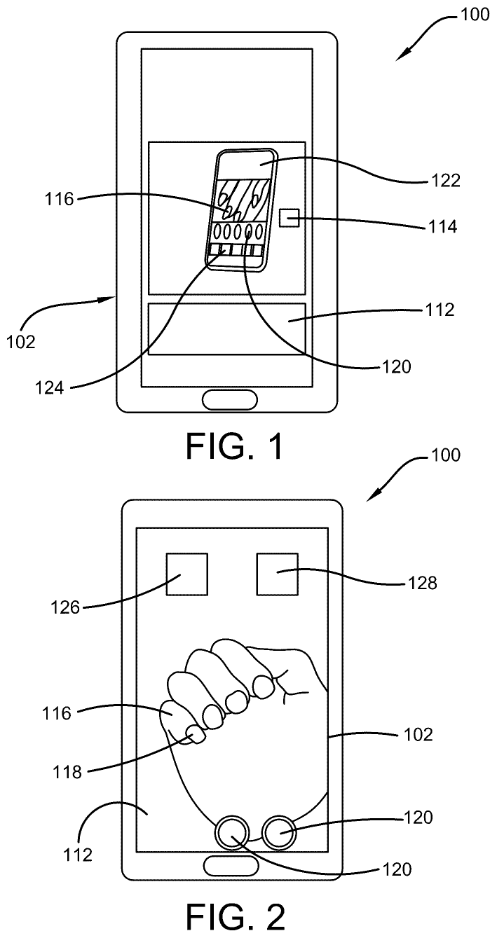

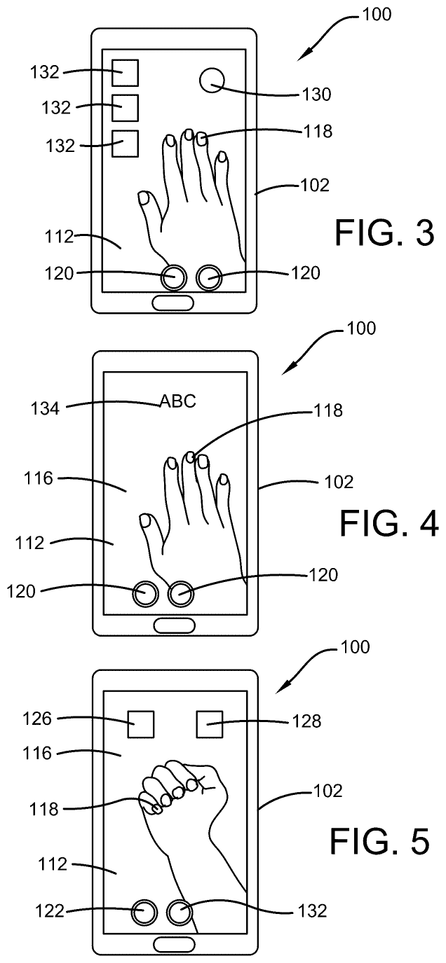

Referring initially to the drawings, FIG. 1-5 illustrate a perspective view of one embodiment of the nail color visualization device 100 of the present invention. In the present embodiment, the nail color visualization device 100 is an improved nail color visualization device 100 that provides a user with a mobile/software application for efficiently choosing nail colors and designs. Specifically, the nail color visualization device 100 is a unique mobile application accessible on a smartphone, tablet, laptop, or a desktop computer (i.e., user device 102). The mobile/software application 100 provides a visual representation of potential nail colors, shapes, lengths, and designs on a user's hand by interfacing with a user's phone camera.

Generally, the nail color visualization device 100 utilizes a smartphone, a tablet, a laptop or a desktop computer, etc., (i.e., user device 102), or any other suitable electronic device that has the required operating and memory parameters to support the mobile application 100 of the present invention.

Further, the mobile application 100 comprises an easy-to-use interface 112. A user would create an account and then log into the mobile application 100. The mobile application 100 then interfaces with a user's phone camera 114. The mobile application 100 will capture the user's hand and nail boundaries, providing a visual overlay of potential nail designs, shapes, lengths, and colors as selected by the user through options in the application. Specifically, the camera view screen 116 will occupy the majority of the display and feature nail detection markers that identify and overlay color, shape and length onto fingernails 118.

Additionally, the color selection palette 120 can be accessible via sideswipe or a bottom menu. The colors displayed would be specific to the nail salon the user is visiting. Thus, users would have limited color options to only what is on site at the specific nail salon location. There can be a salon branding area 122 displaying a logo and business name. Thus, the mobile application 100 allows a nail salon to display their business name prominently across the interface, alerting users to the specific nail salon being serviced. Further, a quick-access history panel 124 can also show recently viewed colors. Thus, users can go back and forth between nail colors, lengths, designs, etc., without having the colors reset each time, this makes it easier for users to compare nails colors and designs and come to a decision quicker. Additionally, a social sharing button 126 would capture nail visualization, and a QR code scanner 128 would be used for salon-specific color access. The social sharing button 126 allows a user to display their nails with the intended colors and designs on their social media accounts, allowing followers to comment and like the images. Further, the QR code scanner 128 grants a user access to the inventory of nail colors for a specific salon.

Additional features can be available on the mobile application 100, such as displaying the ranking of the different colors or brands trending in a specific nail salon, city, and/or country. Users can then choose the most popular color from a specific location, if desired. Further, toggle controls 130 can be used for different nail finish types (i.e., glossy, matte, etc.). Users can toggle back and forth between the nail finishes. Other features 132 can include color search and filter functionality, color information panels, salon inventory indicators, a virtual ‘try on’ button, settings menus, and a help-tutorial overlay for first-time users, etc., or any other specific features as desired by a user and/or nail salon.

Accordingly, the mobile application 100 will allow salon specific inventory entries to limit the options to only what is on site at the location being serviced. Thus, the mobile application 100 allows users the benefit of approving a design or color on their nails 118 before going through the process only to find out that the nail color or design is unavailable at that specific nail salon. Accordingly, the mobile application 100 will have full inventory access to allow for more efficient management of supplies using advanced analytical review and allows social media integration for marketing and ordering.

Generally, the mobile application 100 provides a secure website and/or smart phone app access by users. In addition, the device 100 of the present invention may also include: a web server 108 and Cloud database 110 of nail salon identification and inventory data connectable to the mobile smartphone or portable tablet or computer device 102. Thus, the mobile application 100 allows for providing salon specific inventory access via the web server 108 and Cloud database 110.

In one embodiment of the invention, the nail salon identification and inventory data and data management software are maintained on a Microsoft Cloud server in a typical fashion, or other cloud server, such as the Adobe, Apple or Amazon cloud server, etc. A secure cloud server is used for the protection and security of nail salon identification and inventory data and user information data stored on the cloud server. Thus, nail salon identification and inventory data and user information data are sent to the cloud server and collected. Conveniently, the data is stored and managed with a data management software or program to manage the collected nail salon identification and inventory data, and user data. Accordingly, the data management software or program collects the information and links the information for use in the mobile application. Further, the linked information includes but is not limited to nail salon identification and inventory data, and user data, etc.

Typically, a cellular wireless data network 106 embedded in the computer, tablet or smartphone, etc., (i.e., user device 102), transmits both nail salon identification and inventory data to a user. Such nail salon identification and inventory data can be processed by the user via a Cloud data management server.

In yet another embodiment, the nail color visualization device 100 comprises a plurality of indicia 134. Specifically, the mobile application of the device 100 may include advertising, a trademark, or other letters, designs, or characters, printed, painted, stamped, or integrated into the mobile application, or any other indicia 134 as is known in the art. Specifically, any suitable indicia 134 as is known in the art can be included, such as but not limited to, patterns, logos, emblems, images, symbols, designs, letters, words, characters, animals, advertisements, brands, etc., that may or may not be nail color, salon, or brand related.

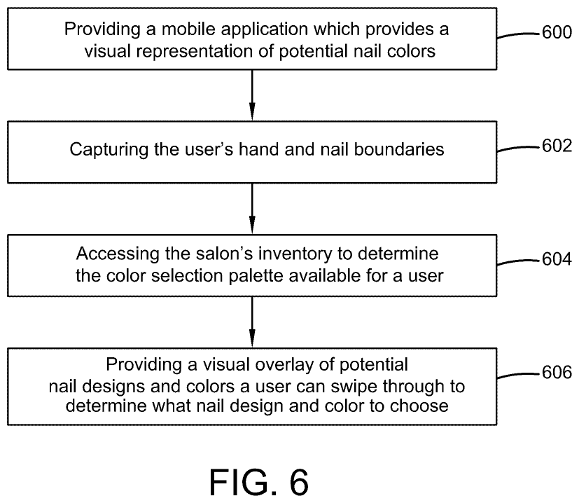

FIG. 6 illustrates a flowchart of the method of displaying a visual representation of potential nail colors, shapes, lengths, and designs. The method includes the steps of at 600, providing a mobile application which provides a visual representation of potential nail colors. The method also includes at 602, capturing the user's hand and nail boundaries. Further, the method comprises at 604, accessing the salon's inventory to determine the color selection palette available for a user. Finally, the method includes at 606, providing a visual overlay of potential nail designs and colors a user can swipe through to determine what nail design and color to choose.

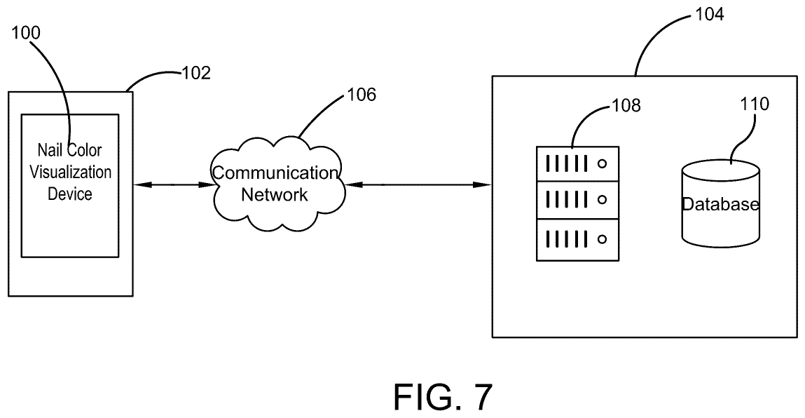

FIG. 7 is a schematic diagram illustrating one embodiment of the nail color visualization device 100 of the present invention. The software/mobile application 100 has a client-server architecture wherein a user accesses the mobile application 100 installed on a user device 102. The mobile application 100 also comprises a server system 104 and the user device 102 is communicatively coupled to the server system 104 via a communication network 106, such as the Internet. The user device 102 is capable of facilitating a user to input data, receive data, and/or transmit data within the mobile application 100. It will be apparent to a user of ordinary skill in the art that the user may be any personnel using the mobile application 100, without deviating from the scope of the disclosure. Examples of the user device 102 may include, but are not limited to, a desktop, a notebook, a laptop, a handheld computer, a touch sensitive device, a tablet, a computing device, a smart-phone, and/or a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a . NET framework, a personal home page (PHP) framework, or any web-application framework, etc. The server system 104 can be maintained by a storage facility management authority or a third-party entity that facilitates service enablement and resource allocation operations of the mobile application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with users'account information from the mobile application 100, as well as nail salon identification and inventory data. In some embodiments, a set of centralized or distributed network of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the mobile application 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the server system 104. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

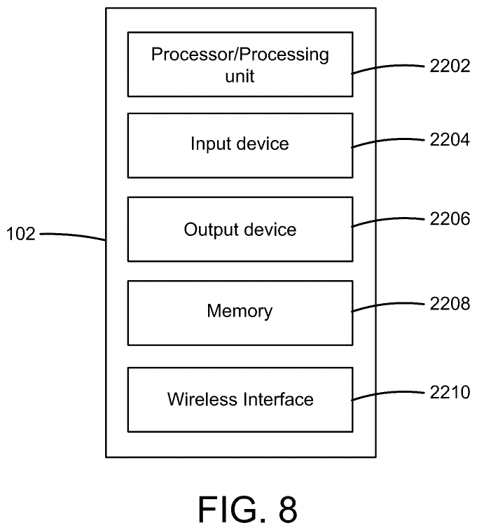

FIG. 8 illustrates an exemplary user device 102 that is used for installing the nail color visualization device 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the mobile application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the mobile application 100.

The user device 102 comprises input device(s) 2204, such as a touch input device, a voice input device, etc., for entering data and information. Preferably, the touch interface of the user device 102 is used as the input and various buttons/tabs shown on the mobile application are pressed or clicked by the user.

Electronic user device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the mobile application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein, “nail color visualization device”, “nail color device”, “visualization device”, and “device” are interchangeable and refer to the nail color visualization device 100 of the present invention.

Notwithstanding the foregoing, the nail color visualization device 100 of the present invention can be of any suitable size and configuration as is known in the art without affecting the overall concept of the invention, provided that it accomplishes the above-stated objectives. One of ordinary skill in the art will appreciate that the nail color visualization device 100, as shown in FIGS. 1-8 is for illustrative purposes only, and that many other sizes and shapes of the nail color visualization device 100 are well within the scope of the present disclosure. Although the dimensions of the nail color visualization device 100 are important design parameters for user convenience, the nail color visualization device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A nail color visualization device that provides a user with a visual representation of potential nail colors and designs, the nail color visualization device comprising:
a mobile application;
wherein the mobile application is accessible on a smart device; and
further wherein a user utilizes the mobile application to efficiently provide a visual representation of potential nail colors, shapes, lengths, and designs on a user's hand.

2. The nail color visualization device of claim 1, wherein the smart device is a smartphone, a tablet, a laptop or a desktop computer.

3. The nail color visualization device of claim 2, wherein the mobile application allows a user to create a secure account and login via an easy-to-use interface.

4. The nail color visualization device of claim 3, wherein the mobile application interfaces with a user's phone camera to capture a user's hand and nail boundaries, and to provide a visual overlay of potential nail designs, shapes, lengths, and colors as selected by the user through options in the mobile application.

5. The nail color visualization device of claim 4, wherein a color selection palette can be accessible via sideswipe or a bottom menu on the mobile application.

6. The nail color visualization device of claim 5, wherein a salon branding area can be included on the mobile application, which displays a logo and business name.

7. The nail color visualization device of claim 6, wherein a quick-access history panel can be included on the mobile application to show recently viewed colors.

8. The nail color visualization device of claim 7, wherein a social sharing button is included to capture nail visualization, and a QR code scanner is used for salon-specific color access.

9. The nail color visualization device of claim 8, wherein the mobile application allows salon specific inventory entries to limit options to only what is on site at a nail salon location being serviced.

10. The nail color visualization device of claim 9, wherein the mobile application provides secure website or smart phone application access by users.

11. The nail color visualization device of claim 10 further comprising a web server and a Cloud database of nail salon identification and inventory data connectable to the smart device.

12. The nail color visualization device of claim 11 wherein nail salon identification and inventory data is stored and managed with a data management software or program.

13. A nail color visualization device that provides a user with a visual representation of potential nail colors and designs, the nail color visualization device comprising:
a mobile application;
wherein the mobile application is accessible on a smart device;
wherein the mobile application allows a user to create a secure account and login via an easy-to-use interface;
wherein the mobile application interfaces with a user's phone camera to capture a user's hand and nail boundaries, and to provide a visual overlay of potential nail designs, shapes, lengths, and colors as selected by the user through options in the mobile application;
wherein a color selection palette can be accessible via sideswipe or a bottom menu on the mobile application;
wherein a quick-access history panel can be included on the mobile application to show recently viewed colors;
wherein a social sharing button is included to capture nail visualization, and a QR code scanner is used for salon-specific color access;
wherein the mobile application allows salon specific inventory entries to limit options to only what is on site at a nail salon location being serviced; and
further wherein a user utilizes the mobile application to efficiently provide a visual representation of potential nail colors, shapes, lengths, and designs on a user's hand.

14. The nail color visualization device of claim 13, wherein the smart device is a smartphone, a tablet, a laptop or a desktop computer.

15. The nail color visualization device of claim 13, wherein a salon branding area can be included on the mobile application, which displays a logo and business name.

16. The nail color visualization device of claim 13 further comprising a plurality of indicia.

17. The nail color visualization device of claim 13, wherein the mobile application provides secure website or smart phone application access by users.

18. The nail color visualization device of claim 17 further comprising a web server and a Cloud database of nail salon identification and inventory data connectable to the smart device.

19. The nail color visualization device of claim 18, wherein nail salon identification and inventory data is stored and managed with a data management software or program.

20. A method of displaying a visual representation of potential nail colors, shapes, lengths, and designs, the method comprising the following steps:
providing a mobile application which provides a visual representation of potential nail colors;
capturing the user's hand and nail boundaries;
accessing the salon's inventory to determine the color selection palette available for a user; and
providing a visual overlay of potential nail designs and colors a user can swipe through to determine what nail design and color to choose.
